(19) United States
(12) Patent Application Publication
(10) Pub. No.: US 2004/0249862 A1
(43) Pub. Date: Dec. 9, 2004

(54) Sync signal insertion/detection method and apparatus for synchronization between audio file and text

(76) Inventors: Seung-Won Shin, Seoul (KR); Won-Ha Lee, Seoul (KR); Nam-Hoon Kim, Anyang-si (KR)

Correspondence Address: TRANSPACIFIC LAW GROUP, 617 NORTH DELAWARE STREET, SAN MATEO, CA, 94401, US

(21) Appl. No.: 10/825,807

(22) Filed: Apr. 16, 2004

(30) Foreign Application Priority Data
Apr. 17, 2003 (KR) 2003-0024306

(51) Int. Cl. G06F 17/00

(52) U.S. Cl. 707/104.1

(57) ABSTRACT

A method for inserting sync signal which can be outputted in synchronization with the text into audio file s while playing audio files, and apparatus thereof are disclosed. First, information of a size of the first part of the frame is obtained from the second part of the frame. Then, based on the obtained information, a start position and a size of the third part of the frame is determined, and at least a part of the sync signal is inserted into the third part of the frame. Therefore, a sync signal can be effectively inserted into audio files without damaging the contents of the audio file.

### BACKGROUND OF THE INVENTION

1. Field of the Invention

The present invention relates to a method for synchronizing digital audio files and texts corresponding thereto in a portable digital playback device and apparatus thereof.

2. Description of the Related Art

Recently, in accordance with the development of computer technology, the technology for playing audio files by using a computer is rapidly developing. In this regard, a function of playing audio files simultaneously with visually indicating details of audio files is attracting attention. For instance, at the same time of playing audio files related to songs, the technology for indicating lyrics of such songs on screen corresponds to such technology.

Referring to FIG. 10, a constitution to simultaneously indicate details of contents while playing audio files in prior art is described hereinbelow.

First, audio files which are subjects for playing and a text file which stores details of audio files are prepared. FIG. 10 is a drawing re-constituting the conventional text file that stores details of audio file in a format of a table. In FIG. 10, the text file is storing not only details of audio files but also a playback point which indicates details of audio files visually. In the embodiment of FIG. 10, during playback of a compressed voice or a music file, a playback point notifying the time for outputting text is stored in a unit of 1/1000 second.

For instance, at the playback point of 0000040 ms, audio files are played, and a row of characters “IN A PORTABLE DIGITAL PLAYBACK DEVICE,” corresponding to such audio files is outputted visually through a predetermined display. As audio files are being played, at the playback point of 0001055 ms, a row of characters “WHILE PLAYING MUSIC OR VOICE FILES,” is outputted simultaneously with the playback of audio files.

That is, the playback point is watched while playing audio files, and if the playback point is consistent with the playback point of the outputted row of characters indicated in the table, the outputted row of characters is outputted.

The structure of the text file such as above is, for instance, substantially similar to the structure of “.smi file” for outputting caption in the moving pictures, which is a structure suitable for a case wherein usable resources such as a computer are sufficiently provided.

However, if digital audio files and texts corresponding thereto are synchronized in a portable digital playback device with the aforesaid method, the usable resources are limited. Accordingly, it is realistically not possible for the portable digital playback device to watch the playback point of ms unit of audio files, and thus to output texts so as to be consistent with such fine playback point. Due to such impossibility, the aforesaid method wherein the playback point and texts are stored in a text file in a format of a table and texts are outputted based on the information of the table is not suitable to the portable digital playback device.

Moreover, since the conventional text outputting method outputs the text information arbitrarily on the liquid crystal screen according to the time played, a problem arises wherein the contents actually played and contents outputted on liquid crystal screen are not consistent to each other.

Next, a method for inserting sync signal into digital audio files as a watermark by the frequency transform etc. is described hereinbelow. Generally, a watermarking technology refers to a technology for storing information of works unrecognizable by ordinary people in a sound source in order to protect copyright, and to determine whether alteration/forgery is made on copyright works, etc. As the watermarking technology hides information defined by a user in the substantial sound source of the copyright work, it is common to use a robust watermark having characteristics wherein said watermark is strong against signal process attacks, compression transformation, etc. and is difficult to remove said watermark with ill intention.

Such watermarking inserts data in the sound source of the digital content, and thus a considerably complicated operation should be carried out in order to detect hidden information again, which accompanies a large amount of memories and calculations. In order to realize the watermarking technology with the ordinary DSP, a considerable amount of resources is consumed and thus a problem arises in which it is difficult to use the watermarking technology to a portable digital playback device such as a portable MP3 player using DSP. Further, additional functions which consume a large amount of resources are not preferable in view of the limited hours of battery duration of the portable playback device. Particularly, since most of the audio data are formatted compressing the subject files, the ordinary watermarking technology is not usable.

A technology for hiding information in the compressed data is disclosed in MP3Stego (Computer Laboratory, Cambridge, August, 1998) suggested by F. Petitcolas. This technology hides data during the process of compressing sound source, and thus a problem arises in which a high speed insertion process is not possible.

Also, Non-Invertible Watermarking Methods For MPEG Encoded Audio (Security and Watermarking of Multimedia Contents, January 1999) suggested by L. Qia and K. Nahrstedt include a high concern for degrading sound source of MP3, and there is a problem of limited amount of information which can be hidden.

Further, a compressed-domain watermarking algorithm for MPEG Audio Layer3 (ACM Multimedia 2001, September 30-October 5, Ottawa, Ontario, Canada) suggested by D. K. Koukopoulos and Y. C. Stamatiou is capable of high speed extraction, but there is a problem in which high speed insertion process can not be carried out.

### SUMMARY OF THE INVENTION

The present invention is contrived to solve the above mentioned problems, and its object is to provide a sync signal insertion method of inserting text and the sync signal into an audio file in order to minimize the effect of text synchronization made upon quality of sound, to enable high speed insertion/process while making the playback point of the audio files consistent with the output point of the text such that audio files and text can be synchronized.

Moreover, another object of the present invention is to provide a method which does not generate excessive resource consumption to the audio files playback device when playing audio files and outputting contents which have been synchronized together therewith.

Also, another object of the present invention is to provide a sync signal detection method and an apparatus for detecting the sync signal from the audio file in which the sync signal has been inserted.

In order to achieve the aforementioned objects, the present invention provides a method of inserting sync signal into audio file containing a plurality of frames, each frame includes a first part in which audio contents are stored, a second part which contains at least information of a size of the first part, and a third part which hardly affects the sound quality after being inserted by the text and the sync signal, comprising steps of obtaining information of a size of the first part of the frame from the second part of the frame; determining a start position and a size of the third part of the frame based on the obtained information; and inserting at least a part of the sync signal into the third part of the frame.

Herein, the first part contains audio contents, the second part contains header information and side information of the audio file, and the third part is a part which hardly affects the sound quality after being inserted by the text and the sync signal in the audio data. Also, the third part contains an area which presents whether the sync signal exists, and an area which presents contents of the sync signal.

Further, the sync signal may contain information of a position of a text which corresponds to the first part of the frame, and the step of inserting at least a part of the sync signal into the third part of the frame comprises steps of deciding whether to insert the sync signal into the third part; and inserting text information which corresponds to the first part of the frame into the third part of the frame in response to the decision of not inserting the sync signal.

Also, it is preferable for the step of inserting at least a part of the sync signal into the third part of the frame to comprise steps of comparing the sync signal inserting space in the third part with the size of the sync signal, and in case that the sync signal inserting space in the third part is smaller than the size of the sync signal, inserting a part of the sync signal into the third part wherein the part of the sync signal has an equivalent size to the sync signal inserting space.

Further, the audio files may be produced by TTS (Text-to-Speech) transformation of the text.

Meanwhile, the present invention provides a method of detecting sync signal from an audio file containing a plurality of frames, each frame includes a first part in which audio contents are stored, a second part which contains at least information of a size of the first part, and a third part which text and sync signal can be inserted into and is within the first part, comprising steps of extracting information of a start position and a size of the third part based on the information of the size of the first part; analyzing the third part to decide whether the sync signal exists; and obtaining at least a part of the sync signal from the third part in response to the decision that the sync signal exists.

Herein, the first part contains audio contents, the second part contains header information of the audio file, and the third part is a part which is not used in playing the audio contents of the audio file. Also, the third part contains an area which presents whether the sync signal exists, and an area which presents contents of the sync signal.

Also, in response to the decision that the sync signal does not exist, the method (of detecting sync signal from an audio file containing a plurality of frames) may further comprise a step of extracting text information from the third part. After analyzing contents of the sync signal, the method may further comprise a step of selecting a position of the corresponding text based on the analysis.

Further, it is preferable for the method to further comprise a step of combining at least a part of the sync signal with at least a part of the sync signal of the subsequent frame, in case that at least a part of the sync signal obtained from the third part is not the same as the sync signal.

Meanwhile, the present invention provides an apparatus for detecting a sync signal from an audio file containing a plurality of frames, each frame includes a first part in which audio contents are stored, a second part which contains at least size information of the first part, and a third part which text and sync signal can be inserted into and is within the first part, comprising a decision portion of extracting information of a start position and a size of the third part based on information of the size of the first part, and deciding whether the sync signal exists by analyzing the third part; and a sync signal obtaining portion of obtaining at least a part of the sync signal from the third part in response to the decision that the sync signal exists.

### BRIEF DESCRIPTION OF THE DRAWINGS

FIG. 1 is a conceptual diagram illustrating overall process for synchronizing audio files and texts corresponding thereto in the portable digital playback device;

FIG. 2 is a drawing showing the structure of the MP3 frame;

FIG. 3 is a flow diagram showing a sync signal insertion process according the first embodiment of the present invention;

FIG. 4 is a flow diagram showing a sync signal insertion process according to the second embodiment of the present invention;

FIG. 5 is a schematic diagram illustrating audio files inserted with a sync signal according to the second embodiment of the present invention in a unit of a frame;

FIG. 6 is a conceptual diagram illustrating a process for synchronizing audio files and texts generated with a TTS technology;

FIG. 7 is a schematic diagram schematically explaining the process of detecting the sync signal according to the present invention.

FIG. 8 is a block diagram showing the inside with regard to a case wherein a sync signal detection device for synchronizing texts according to the present invention is realized on DSP of the portable digital playback device;

FIG. 9 is a block diagram showing the inside with regard to realization of DSP of the portable digital playback device; and

FIG. 10 is a drawing re-constituting the conventional text files which store details of audio files in a form of a table.

### DETAILED DESCRIPTION

Embodiments of the present invention will be described in detail with reference to the drawings in the following.

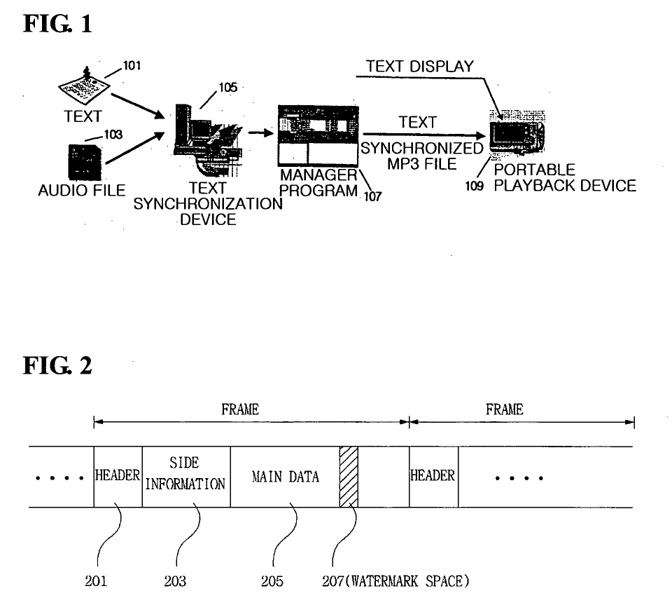

FIG. 1 is a conceptual diagram illustrating overall process for synchronizing audio files and texts corresponding thereto in the portable digital playback device.

Referring to FIG. 1, first, audio file 103 and the text 101 corresponding thereto are inputted to a text synchronization device 150. By using the inputted information, users directly input the point of time each of lyrics is to be outputted in the text synchronization device 105. Information inputted by users may be constituted with text to be outputted and information connected to the playback time, respectively. The text synchronization device 105, according to the sync signal insertion method of the present invention, inserts text data and output point for outputting text corresponding to a predetermined position of the audio file 103.

Thereafter, in a case wherein the portable playback device 109 plays the audio file 103, if the sync signal is detected during the audio file playback, such sync signal is analyzed, text data is searched according to the sync signal, and the searched row of characters is outputted by a display means of the portable playback device 109.

Hereinbelow, the embodiment of the present invention describes the format of the music file as MP3. However, in a case of music files stored according to other different audio file formats such as WMA, AAC, AC3, etc., it is obvious for the one skilled in the art to adapt or apply the sync signal insertion method of the present invention to those files.

FIG. 2 is a drawing showing the structure of the MP3 frame. Referring to FIG. 2 to explain the structure of the MP3 frame, MP3 audio file is constituted with a series of plurality of frames, and each frame includes a header 201 comprising 12 bits of synchronized bits, side information 203, main data 205, and a stuffing space 207.

The header 201 and the side information 203 store the overall information concerning the structure of the frame, etc. including sync. The main data 205 compresses and stores audio contents without any loss according to the Huffman Coding method. The compressed main data 205 without any loss is to be stored in a unit of a bit, and as a result of the Huffman Coding, surplus bits which do not include the audio contents at all are generated. Such surplus bits are called stuffing bits, if stuffing bits are used, text data can be inserted without affecting the sound quality. Although the size of stuffing bits depends on the compressing method, stuffing bits are not large enough to contain all the text data in MP3, so it is not possible to insert the text information only by using the stuffing bits.

So, it is desirable to analyze main data (205), search the data region which least affects the sound quality, and to use the region as a text hiding place. The space which least affect the sound quality is high-frequency region among main data (205), and it is possible to insert text data in this data region. The part which hardly affects the sound quality among the main data and represents high-frequency band signal is called watermark space (207), and data is inserted by using the watermark space (207).

Hereinbelow, as set forth in more details, the present invention uses the constitutional characteristics of the frame and inserts sync signals in the watermark space.

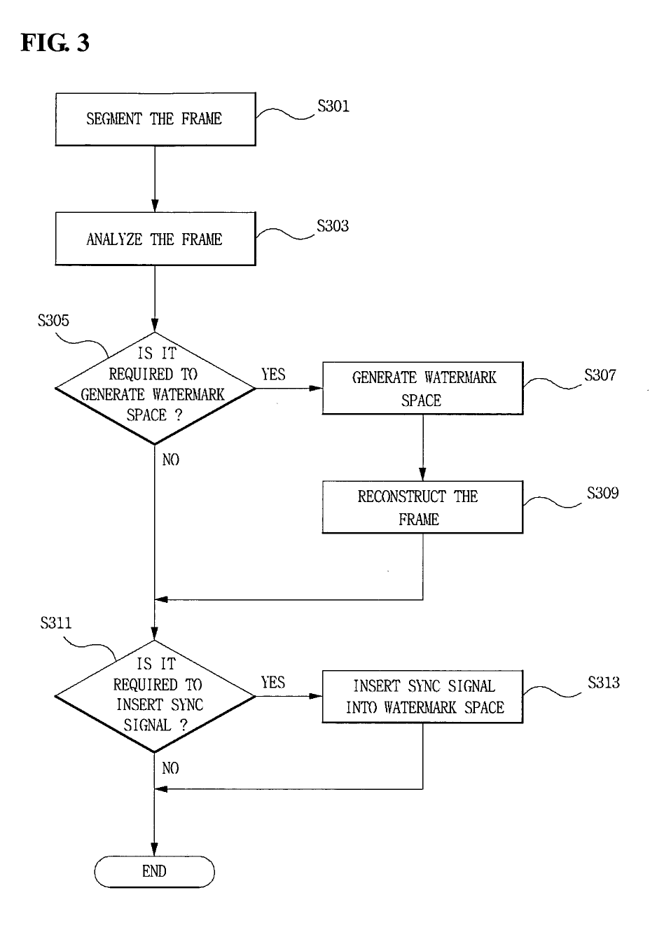

FIG. 3 is a flow diagram showing a sync signal insertion process according to the first embodiment of the present invention. Referring to FIG. 3, first, if the MP3 audio file to be played is selected, such file is divided into a unit of a frame (S301).

With regard to each of the divided frame, a frame analysis is performed (S303). The frame analysis analyzes the header 201 and the side information 203 so as to obtain information concerning the starting position of the main data 205 and information concerning its size. Thereafter, based on the information concerning the size of the main data 205, the size and the position of the watermark space 207 are obtained. Watermark space 207 is a data convertible region within the remaining bits of the frame and high-frequency representing region.

Thereafter, it is determined whether the sync signal should be inserted in the pertinent frame (S311). Determining whether the sync signal is inserted may be considered according to the information previously inputted by the user. For instance, the user may directly input information for outputting which portion of the text at which point of time through a predetermined input device of the text synchronization device while playing the audio file. Also, similar to a case adopting a TTS method mentioned later, it may be automatically determined. In a case wherein the sync signal is to be inserted, the sync signal is inserted in the stuffing space (S313). Since the size of the sync signal is generally bigger than the number of bits of the stuffing space, the entire one sync signal is not inserted into one stuffing space, but at least portion of the sync signal is inserted into one stuffing space. One sync signal may be inserted into a plurality of stuffing spaces. In the exemplary embodiment, the stuffing space includes a part indicating existence of the sync signal, and a part indicating the position of the text as the contents of the sync signal and the number of characters of the text to be outputted. Determining how many bits of the sync signals are inserted in the pertinent frame depends on how many bits the provided stuffing space have.

By repeating the aforementioned process with regard to each frame, the sync signals are inserted into audio files comprised of frames.

Hence, through the aforementioned constitution, by providing sync signals which are inserted in the audio file in order to synchronize the audio files and texts, at the time of playing audio files and outputting texts synchronized therewith, an excessive resource consumption will not occur in the audio files playback device.

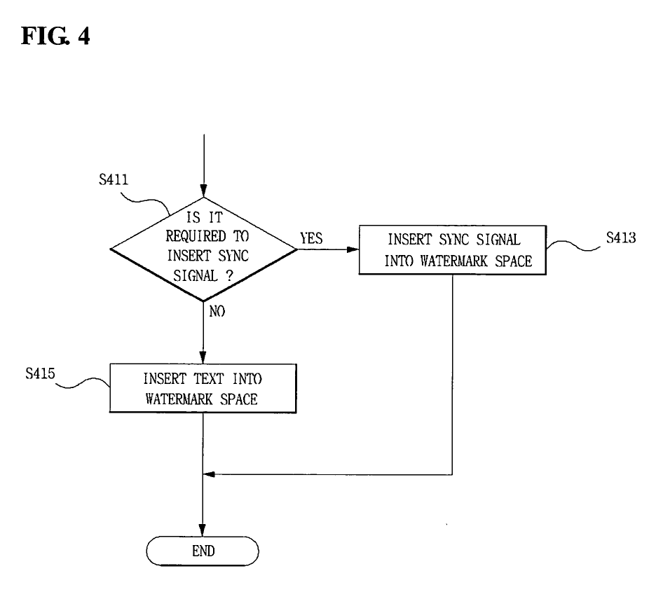

Next, referring to FIGS. 4 & 5, the second embodiment of the present invention is described. FIG. 4 is a flow diagram showing a sync signal insertion process according to the second embodiment of the present invention.

Although not illustrated in FIG. 4, Steps of S301 to S309 of FIG. 3 are identically included prior to S411 of FIG. 4. Illustration and explanation thereof will be omitted for convenience.

First of all, whether it is necessary to insert sync signals will be determined (S411).

If it is not necessary to insert sync signals, texts are inserted in the watermark space (S415). Since the length of the row of characters of texts is generally longer than the number of bits in the watermark space, the entire row of characters of the given texts is not inserted in a single watermark space, but at least a part of the row of text characters is inserted in a single watermark space. That is, a plurality of watermark spaces is inserted with a single row of text characters.

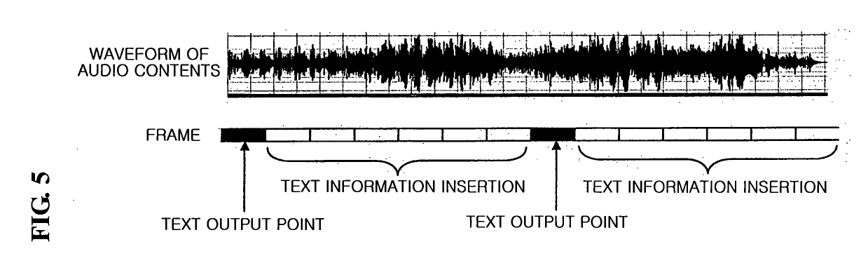

FIG. 5 is a schematic diagram illustrating audio files in which sync signal is inserted in accordance with the second embodiment of the present invention in a unit of frames. In FIG. 5, audio files are schematically illustrated by being segmented in a unit of frames. Regarding each frame, the frame corresponding to text information insertion includes text information and the frame corresponding to text output point includes sync signal. The frame corresponding to text information insertion may not include any inserted information at all in the stuffing space, and as described above, this means a waiting zone. First, the text information to be outputted is inserted into one or more frames so that the playback point of the frame including a sync signal becomes the point outputting the text already inserted in the previous frame. After all of the text information to be outputted is inserted, the frame stays in a waiting status until a sync signal is inserted. In the waiting status, no separate information is inserted into the frame and all of the stuffing bits existing in each frame are initialized to ‘0’. Then, if the position of the present frame becomes consistent with the time information of the text to be outputted, the sync signal is inserted.

Now, back to FIG. 4, if a sync signal is to be inserted, the sync signal should be inserted into the watermark space (S413). As described above referring to FIG. 3, since the size of a sync signal is generally larger than the number of bits of a watermark space, not only can the entire sync signal be inserted in one watermark space, but also at least a part of the sync signal can be inserted in one watermark space. That is, one sync signal can be inserted in a plurality of watermark spaces. It is sufficient for the sync signal to be inserted in the watermark space only to include the part indicating the existence of the sync signal. This is because when playing the audio file, since the information stored in the watermark space of the previous frames of the frame wherein the sync signal is detected are fragments of text information, if they are collected, the text to be outputted by the display can be obtained when detecting whether the sync signal exists.

By repeating the above process for each frame, the sync signal and text corresponding to the audio file is inserted into the audio file comprised of frames.

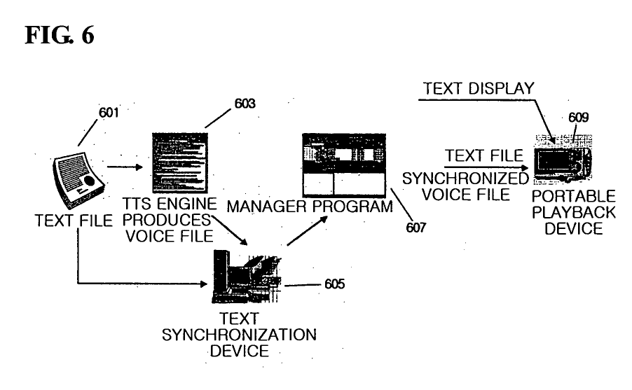

Meanwhile, the process of synchronizing audio files and lyric texts in accordance with the present invention may be obtained by using the TTS (Text-to-Speech) engine. FIG. 6 is a conceptual diagram illustrating a process of synchronizing voice files and texts produced by the TTS technology.

TTS is a technology for transforming texts into voice files by voice synthesis. When transforming text characters into audio files, the TTS engine 603 establishes a phoneme DB of the smallest phonetic unit of the language of each country. Then considering the context of the text characters, the searched phoneme DBs are synthesized to generate a voice signal. In the description of the constitution of the present invention referring to FIG. 1, the location of the audio file and the text to be synchronized must be directly inputted by the user. However, as for voice synthesis by TTS, the location of the text in the corresponding text file can be automatically located at the same time of producing a voice file, and thus no separate user input process is required.

The process of detecting the sync signal in accordance with the present invention will be described in the following.

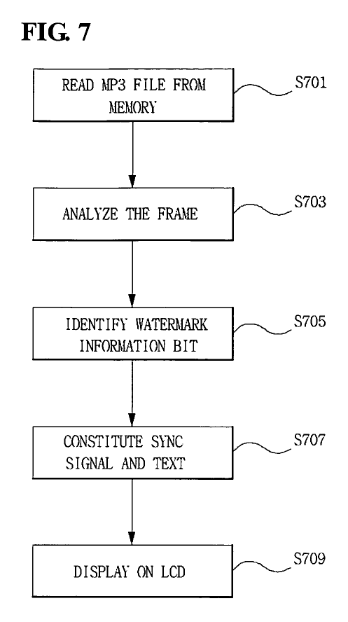

FIG. 7 is a schematic diagram schematically illustrating the process of detecting the sync signal in accordance with the present invention.

MP3 audio files are stored in the memory. Information on the MP3 audio files is read from the memory in response to the playback instructions of the MP3 audio file (S701). The read MP3 audio files are provided in a form of MP3 stream in order to analyze the frame.

Then, the audio files transmitted in the form of MP3 stream are segmented into a unit of frames (S703).

Then, Watermark information bit identifier extracts size of audio contents by using header and side information for each frame. Based on the size of audio contents, it is possible to know the position of value representing optimal high-frequency band signal and position of stuffing bits. Then, if the watermark is inserted, detected information and bit size of the information is transferred to sync signal and text constitutor.

Then, the contents of the detected sync signal are analyzed to constitute a sync signal and text (S707). In the first embodiment, the location of the text in the text files indicated by the sync signal and the length of the row of characters to be presented are determined, and thus the corresponding row of characters is read from the text file. Meanwhile, as for the second embodiment wherein the text is included in the MP3 audio file, if a sync signal does not exist, the contents of the watermark space 207 is read, and then continuously stored in a separate memory space. If a sync signal is detected, the contents stored in the memory space are outputted as a text. After being outputted as a text, said contents are removed from the memory space. Then, the row of characters comprising text is provided to be displayed on an LCD.

Then, the LCD controller (not shown) controls the LCD so that the row of characters currently displayed on the LCD is deleted and a new row of characters is displayed (S709). In this case, if a text longer than the row of characters which can be simultaneously displayed on an LCD is to be outputted, the row of characters can be automatically scrolled from the right to the left, and such scrolling process is known to the one skilled in the art.

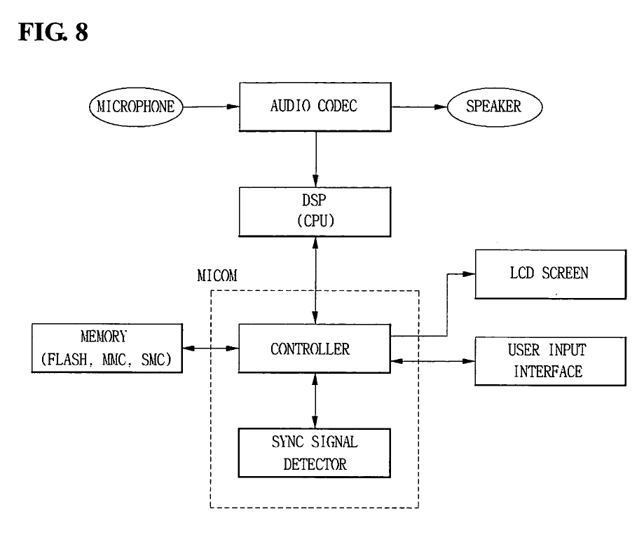

The sync signal detector of FIG. 7 can be realized at a portable digital playback device as shown in FIGS. 8 & 9. In general, it is realized in a DSP, however since the MICOM controls all external devices for text synchronization, if there is enough resource left in the MICOM, it is preferable to be realized at the MICOM as shown in FIG. 8. When realizing synchronization using the method proposed in the present invention, less time and memory are to be spend, and thus it can be easily realized at a MICOM.

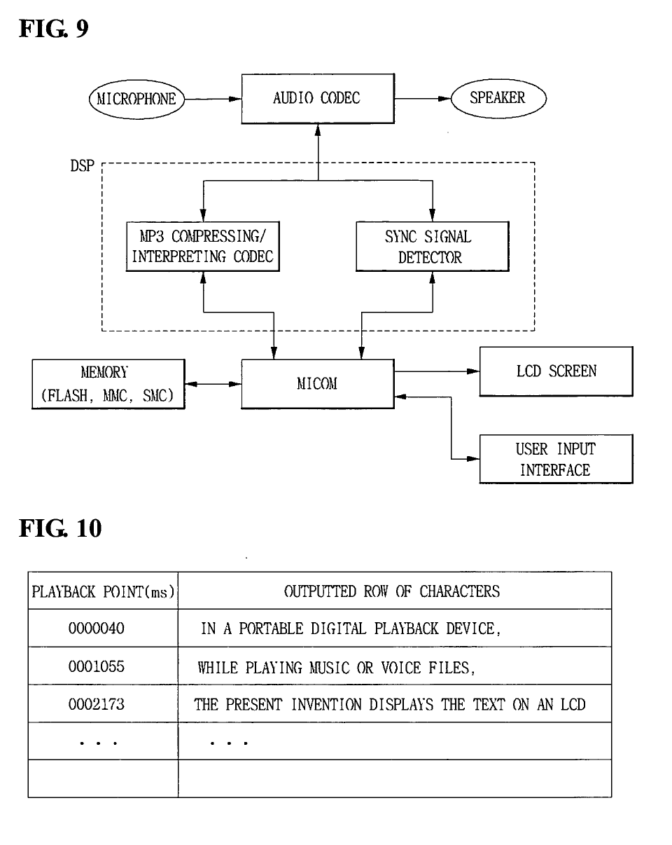

FIG. 8 is a block diagram showing the inside with regard to a case wherein a sync signal detection device for synchronizing texts in accordance with the present invention is realized on DSP of the portable digital playback device; and FIG. 9 is a block diagram showing the inside with regard to realization of DSP of the portable digital playback device.

FIGS. 8 & 9 are block diagrams showing the inside of ordinary playback devices wherein the name of the file to be played is brought from the MICOM when the user presses the play button. After bringing the name of the file to be played, the data of said file is read and transmitted to the buffer. In the DSP, the data compressed in the buffer are decoded, and music is played through the speaker.

If the present invention displaying lyrics or voice information of files to be played on the LCD is inserted into this process, its entire structure is changed as the following. The process of bringing the file to be played at the MICOM is the same. After bringing the file to be played, the data read from the played file is transmitted to the buffer, and the sync signal detector searches whether there is a sync signal in the transmitted data. At this time, if a sync signal is detected at the sync signal detector, the controller of the MICOM informs that the sync signal is found and what the contents of the sync signal that is found is. At the LCD controller of the MICOM, the information received from the sync signal detector is displayed on the LCD.

The difference between FIG. 8 and FIG. 9 is only where the sync signal detector is located. However, the entire prosecution is the same regardless of which form it takes to serve the constitutional characteristics of the portable playback device.

The present invention is described with reference to specific embodiments regarding specific applications. A person having ordinary skill in the art may make additional modifications, applications and embodiments within the scope of the present invention.

Therefore, the following claims are recited to cover all applications, modifications and embodiments within the scope of the present invention.

The present invention provides a function which can display music lyrics or voice contents which are automatically played on the LCD when playing music files or voice files by adding a text synchronization device to the portable digital playback device.

The present invention detects the sync signal hidden in music files during the compressed files being played in real-time, and displays in synchronization with the point at which the contents file currently being played on an LCD. Therefore, the user can confirm the contents currently being played through the LCD of the playing device. Also, by hiding all information in digital content until the text information and the text are outputted, the user does not have to store the text file or other information separately.

In particular, since the present invention can be widely applied from ordinary music lyrics to teaching materials for studying foreign languages, it can be effectively used in portable digital playback devices used for language study.

What is claimed is:

1. A method of inserting sync signal into audio file containing a plurality of frames, each frame includes a first part in which audio contents are stored, a second part which contains at least information of a size of the first part, and a third part which text and sync signal can be inserted into and is within the first part, comprising:
(a) obtaining information of a size of the first part of the frame from the second part of the frame;
(b) determining a start position and a size of the third part of the frame based on the obtained information; and
(c) inserting at least a part of the sync signal into the third part of the frame.

2. The method according to claim 1, wherein the first part contains the audio contents, the second part contains header information of the audio file, and the third part is a part which is within the first part and least affects the sound quality while playing audio file.

3. The method according to claim 1, wherein the third part contains an area which presents whether the sync signal exists, and an area which presents contents of the sync signal.

4. The method according to claim 1, wherein the sync signal contains information of a position of a text which corresponds to the first part of the frame.

5. The method according to claim 1, wherein said step (c) comprises:
deciding whether to insert the sync signal into the third part; and
inserting text information which corresponds to the first part of the frame into the third part of the frame, in response to the decision of not inserting the sync signal.

6. The method according to any one of claims 1 to 5, wherein said step (c) comprises:
comparing the sync signal inserting space in the third part with the size of the sync signal, and in case that the sync signal inserting space in the third part is smaller than the size of the sync signal, inserting a part of the sync signal into the third part wherein the part of the sync signal has an equivalent size to the sync signal inserting space.

7. The method according to claim 1, wherein the audio contents are produced by TTS (Text-to-Speech) transformation of the text.

8. A method of detecting sync signal from an audio file containing a plurality of frames, each frame includes a first part in which audio contents are stored, a second part which contains at least information of a size of the first part, and a third part which text and sync signal can be inserted into and is within the first part, comprising:
extracting information of a start position and a size of the third part based on the information of the size of the first part;
analyzing the third part to decide whether the sync signal exists; and
obtaining at least a part of the sync signal from the third part, in response to the decision that the sync signal exists.

9. The method according to claim 8, wherein the first part contains the audio contents, the second part contains header information of the audio file, and the third part is a part which is not used in playing the audio contents of the audio file.

10. The method according to claim 8, wherein the third part contains an area which presents whether the sync signal exists, and an area which presents contents of the sync signal.

11. The method according to claim 8, further comprising:
extracting text information from the third part, in response to the decision that the sync signal does not exist.

12. The method according to claim 8, further comprising:
analyzing contents of the sync signal, and thereafter constituting text information corresponding text based on the analysis.

13. The method according to any one of claims 8 to 12, further comprising:
combining at least a part of the sync signal with at least a part of the sync signal of the subsequent frame, in case that at least a part of the sync signal obtained from the third part is not the same as the sync signal.

14. An apparatus for detecting a sync signal from an audio file containing a plurality of frames, each frame includes a first part in which audio contents are stored, a second part which contains at least information of a size of the first part, and a third part which text and sync signal can be inserted into and is within the first part, comprising:
a decision portion of extracting information of a start position and a size of the third part based on information of the size of the first part, and deciding whether the sync signal exists by analyzing the third part; and
a sync signal obtaining portion of obtaining at least a part of the sync signal from the third part, in response to the decision that the sync signal exists.
